(19) United States
(12) Patent Application Publication
(10) Pub. No.: US 2009/0275361 A1
(43) Pub. Date: Nov. 5, 2009

(54) FOLDING PORTABLE TELEPHONE

(75) Inventor: Jun Takahashi, Miyagi (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/718,542

(22) PCT Filed: Nov. 9, 2004
(86) PCT No.: PCT/JP2004/016576

§ 371 Date: May 3, 2007

(51) Int. Cl. H04M 1/00

(52) U.S. Cl. 455/556.1; 455/575.3; 455/575.3

(57) ABSTRACT

There is provided a folding-type cellular phone capable of promptly performing a camera photographing in a short time after a housing is unfolded. A folding-type cellular phone 100 is configured to include an upper housing 3 which has a display section 2, a lower housing 5 which has a manipulation section 4, and a hinge section 6 which connects the upper housing 3 and the lower housing 5 to each other so as to fold and unfold the housings relative to each other. Moreover, the folding-type cellular phone 100 is provided with a button 7 for unfolding the upper housing 3 relative to the lower housing 5 up to a extent that the lower housing 5 can be manipulated. Additionally, the upper housing 3 includes a camera-side surface 9 that has a camera 8, and a display-side surface 10 which is disposed on the opposite side of the camera-side surface 9 and is used to display a photographed image, and a button 7 is disposed on an end surface of the hinge section. Additionally, the button 7 is supported by a support hole 11 which is provided to the end surface of the hinge section of the upper housing 3 so as to reciprocate through the support hole 11, and a protrusion-shaped contact 20 constituted by a conductive member 12 and a elastic member 13 is provided to the button 7 and brought into contact with a substrate-side contact portion 14 when the button 7 is pressed. With application of electricity therebetween for a predetermined time, the camera 8 is activated, and a photographing can be performed when the button 7 is pressed again.

### TECHNICAL FIELD

The present invention relates to a folding-type cellular phone equipped with a camera, and more particularly, to a folding-type cellular phone in which a camera activating function and a shutter function are assigned to a button for unfolding a housing.

### BACKGROUND ART

Among types of cellular phones, folding-type cellular phones are widely used. This is because the cellular phones are required to have a function of a viewer of visual information such as texts or images as well as a terminal for a voice call. In this respect, in the folding-type cellular phones, it is easy to form a display section to have a size suitable for realizing such functions. Recently, such the folding-type cellular phones are equipped with a camera in which a photographed image is displayed on the display section.

Among known cellular phones, there are folding-type cellular phones of one push open type in which the folding-type cellular phones are unfolded by simply pressing a button provided to the folding-type cellular phones so that the user can simply unfold the folding-type cellular phones with one hand (for example, see JP-A-11-041328). The cellular phones have a button assembly on an end surface of its hinge section, and a function of unfolding the housing by the user pressing the button assembly is assigned to the button assembly. Moreover, the button assembly which is disposed on the one surface of the hinge section and used to unfold the housing has a lock function of locking and maintaining a state where a compression coil spring and the housing are folded. When the button on the hinge section is pressed, the lock function is released, and a main body of the display section can be unfolded in a one-touch manner up to the extent allowing user's manipulation.

Meanwhile, in the folding-type cellular phone equipped with the camera, the display section functioning as a camera's view finder is positioned at the inner side of the folded housing. Namely, when the user takes a photograph using the phone, the user should go through due procedures such as unfolding the housing to activate the camera function and pressing a shutter button while monitoring a target object on the display section.

However, in the above-mentioned cellular phone, prompt photographing cannot be made when the housing is in the folded state. Additionally, there may be cases in which the user presses the wrong button by mistake due to haste and thus missing a chance for taking a photograph using the camera function.

Patent Document 1: JP-A-11-041328

### DISCLOSURE OF THE INVENTION

### Problems that the Invention is to Solve

The present invention provides a folding-type cellular phone enabling prompt and simple way of photographing using a camera function even when housing is in the folded state.

A folding-type cellular phone according to the invention includes a first housing, a second housing, a hinge section which unfoldably connects the first housing to the second housing, a button unit which is provided inside the second housing and which drives the hinge section so as to unfold the first housing relative to the second housing up to a position at which the second housing can be manipulated, a control unit which interlocks with a driving manipulation of the hinge section by the button unit, and a camera which is provided to one of the first housing and the second housing and which is controlled by the control unit.

It may be possible to configure such that the first housing includes the camera and a display section that displays an image photographed by the camera, and the second housing includes a manipulation section. Additionally, it may be possible to configure such that the first housing includes a display-side surface which is provided with the display section and a camera-side surface which is formed on the opposite side of the display-side surface and which is equipped with the camera and a part of the button unit is exposed to the outside of the second housing from an end surface of the hinge section.

Furthermore, it is preferable that a support hole is formed in the end surface. Additionally, it may be possible to configure such that the button unit includes a button that is held by the support hole to reciprocate, a protrusion-shaped contact provided in the button, a substrate-side contact portion which is connected to a substrate disposed inside the second housing and which makes contact with the protrusion-shaped contact when the button is pressed.

It may be possible to configure such that the protrusion-shaped contact includes an elastic member that can be elastically deformed. Additionally, it may be possible that the protrusion-shaped contact includes a conductive member that contacts with the substrate-side contact portion when the button is pressed. In this case, it may be possible that the button includes a large-diameter portion and a small-diameter portion that protrudes from the large-diameter portion, and the elastic member and the conductive member are formed in a ring shape and disposed adjacent to each other outside the small-diameter portion. In addition, it may be possible to configure such that the substrate-side contact portion includes two electrodes and the conductive member contacts with the two electrodes when the button is pressed.

It may be possible that a timer which measures a time when the protrusion-shaped contact contacts with the substrate-side contact portion is provided and the timer outputs a signal based on the time to the control unit

Additionally, the invention includes a button unit applied to a folding-type cellular phone of one push open type having the above-mentioned configuration.

As described above, at the time of taking a photograph with a camera by using a folding-type cellular phone according to the invention, it is possible to take simply a photograph with the camera in a short time by activating the camera without adjusting the cellular phone after housing is unfolded by using a button for unfolding the housing.

Generally, the folding-type cellular phone includes an upper housing and a lower housing that are unfoldably connected to each other in a hinge section, and one of the upper housing and the lower housing constitutes one of the above-described first housing and second housing.

### BRIEF DESCRIPTION OF THE DRAWINGS

FIGS. 1A and 1B are entire perspective views showing an unfolded/folded state of a folding-type cellular phone according to an embodiment of the invention.

FIGS. 2A and 2B are exploded perspective views showing the folding-type cellular phone according to the embodiment of the invention.

FIGS. 3A and 3B are respectively an enlarged view and a sectional view of a hinge section of the folding-type cellular phone according to the embodiment of the invention.

FIG. 4 is a top plan view showing a substrate-side contact portion of the folding-type cellular phone according to the embodiment of the invention.

FIG. 5 is a block diagram for explaining an operation of the folding-type cellular phone according to the embodiment of the invention.

### DESCRIPTION OF REFERENCE NUMERALS AND SIGNS

1: MAIN BODY
2: DISPLAY SECTION
3: UPPER HOUSING
4: MANIPULATION SECTION
5: LOWER HOUSING
6: HINGE SECTION
7: BUTTON
8: CAMERA
9: CAMERA-SIDE SURFACE
10: DISPLAY-SIDE SURFACE
11: SUPPORT HOLE
12: CONDUCTIVE MEMBER
13: ELASTIC MEMBER
14: SUBSTRATE-SIDE CONTACT PORTION
15: SUBSTRATE
16: CONNECTOR
17: FLEXIBLE SUBSTRATE
18: CONTROL UNIT
19: TIMER
20: PROTRUSION-SHAPED CONTACT
21: BUTTON UNIT
100: FOLDING-TYPE CELLULAR PHONE

### BEST MODE FOR CARRYING OUT THE INVENTION

Hereinafter, an embodiment of the invention will be described with reference to the drawings.

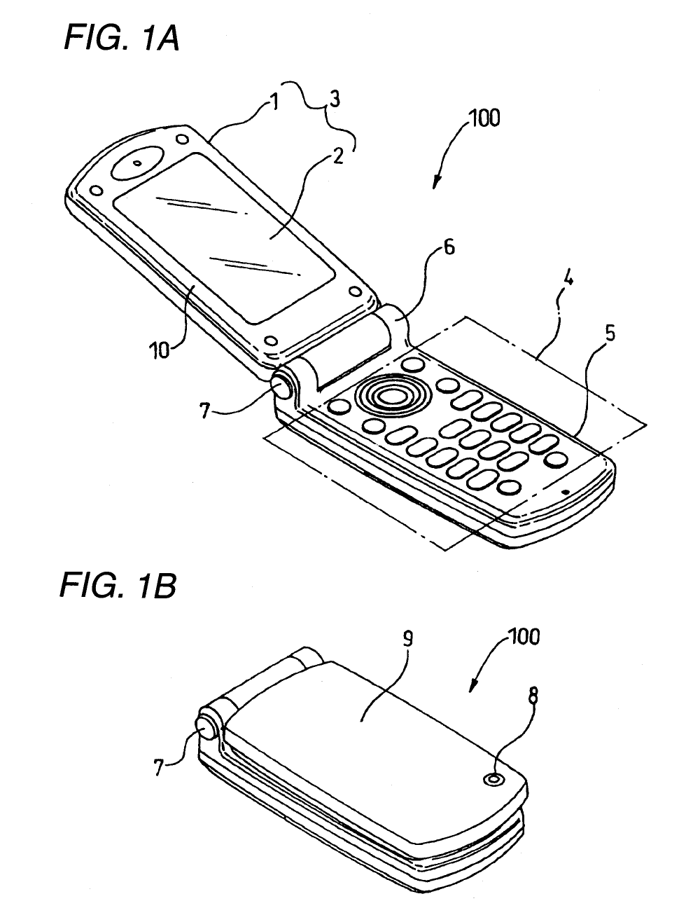

FIG. 1A is an entire perspective view showing an unfolded state of a folding-type cellular phone 100 according to the embodiment of the invention. The folding-type cellular phone 100 includes an upper housing 3, a lower housing 5, and a hinge section 6 connecting the housings to each other so that to the housings can be unfolded and folded. Additionally, the folding-type cellular phone 100 includes a button 7 provided on an side surface of the hinge section 6 in order to unfold the lower housing 5 up to the extent that the lower housing 5 can be manipulated, and the upper housing 3 and the lower housing 5 are unfolded relative to each other.

In the embodiment, the upper housing 3 constitutes a first housing, and the upper housing 3 includes a main body 1 and a display section 2. The display section 2 is configured as an LCD monitor or the like, and the main body 1 includes a camera 8 to be described later, a speaker (not shown), and the like.

In the embodiment, the lower housing 5 constitutes a second housing, and the lower housing 5 includes a manipulation section 4. Additionally, the lower housing 5 includes various manipulation keys for inputting, a microphone, and the like.

The hinge section 6 includes therein a spring that is biased into a direction in which two housings are unfolded relative to each other, a holding mechanism that holds a state that the two housings are unfolded, and the like. The mechanism described in JP-A-11-041328 as mentioned above or other known mechanism may be used as the holding mechanism of the hinge section 6.

FIG. 1B is an entire perspective view showing a folded state of the folding-type cellular phone 100. A display-side surface 10 is formed on one side of the upper housing 3, and a camera-side surface 9 provided with a camera 8 is formed on the opposite side thereof. The display-side surface 10 on which the display section 2 is formed displays an image which is taken with the camera 8.

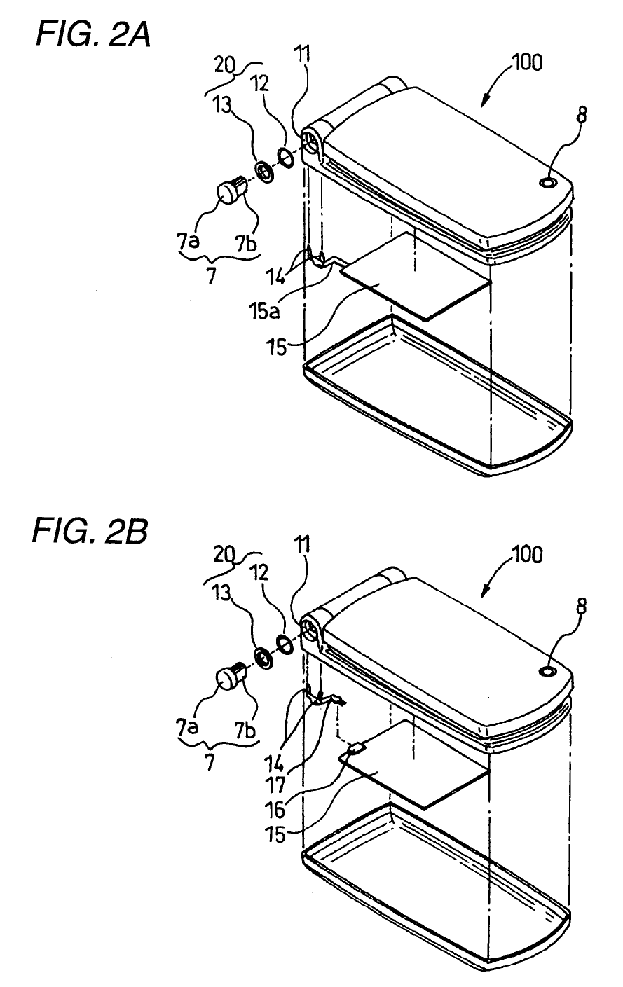

As shown in FIGS. 2A and 2B, the button 7 is supported by a support hole 11 formed on the side surface of the hinge section of the upper housing 3 so as to reciprocate through a width direction (a longitudinal direction of the hinge section 6) of the folding-type cellular phone 100. Additionally, the button 7 is formed with a protrusion-shaped contact 20 including a ring-shaped conductive member 12 and a ring shaped elastic member 13 formed of a rubber or the like. The protrusion-shaped contact 20 is formed on the head portion of the button 7; that is, the protrusion-shaped contact 20 is formed concentrically on the outer periphery of a small-diameter portion 7b which protrudes upward from a large-diameter portion 7a that forms a pressed portion.

Additionally, as shown in FIG. 2A, a substrate 15 is disposed inside the lower housing 5, and a flexible substrate 15a protruding from an end of the substrate 15 forms a substrate-side contact portion 14. When the user presses the button 7, the protrusion-shaped contact 20 is brought into contact with the substrate-side contact portion 14.

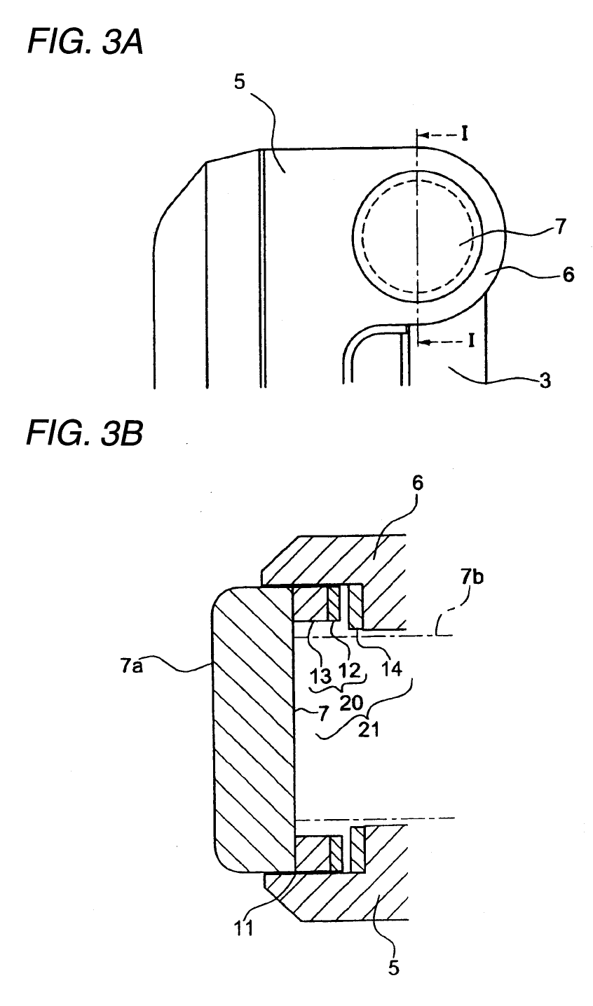

FIG. 3B is a sectional view taken along the I-I line in FIG. 3A. The button 7, the conductive member 12, the elastic member 13, and the substrate-side contact portion 14 constitute a button unit 21. The conductive member 12 is formed of a conductive material such as a carbon, a conductive rubber, or the like. The button unit 21 has a configuration in which the conductive member 12 is brought into contact with the substrate-side contact portion 14 when the elastic member 13 is deformed by the user pressing the button 7.

As is obvious from the above description, in the embodiment, the button unit 21 may be considered as a component, that is, a sub-assembly of the cellular phone 100, which is built in the lower housing 5. The button unit 21 accomplishes a role in which the hinge section 6 is operated so as to unfold the upper housing 3 relative to the lower housing up to the extent that the lower housing housing 5 can be manipulated . “Manipulation position” means relative positions of the two housings in which the button unit 21 is manipulated so as to unfold the two housings and the user manipulates the lower housing while monitoring the display section 2. As a mechanical connection of the button unit 21 and the hinge section 6, configurations disclosed in JP-A-11-041328 and the like can be employed. In other words, it is possible to employ various configurations in which the two housings are unfolded by a press operation from a side of the housing. Actually, the small-diameter 7b of the button 7 is connected to a hinge mechanism.

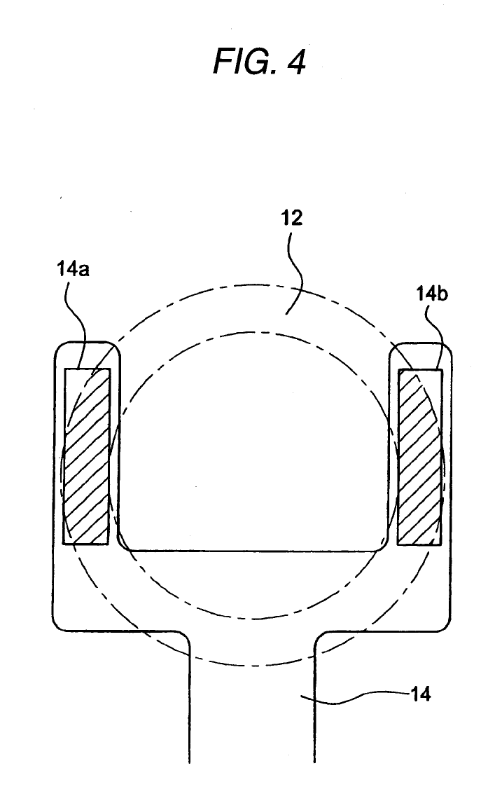

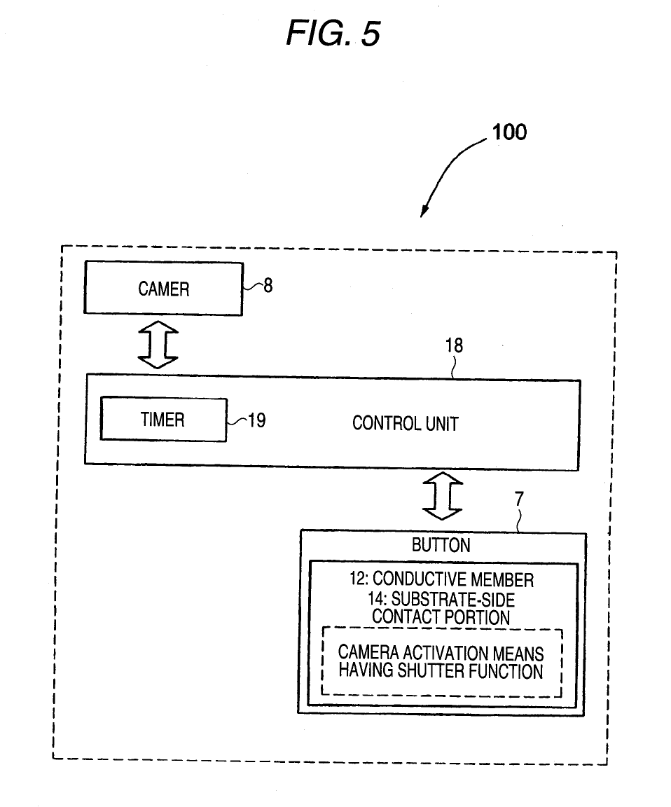

Additionally, as a top plan view shown in FIG. 4 the electrodes 14a and 14b are provided in the substrate-side contact portion 14. As described above, in an example shown in FIG. 2A the electrodes 14a and 14b are configured as a flexible substrate portion 15a of the substrate 15 disposed inside the lower housing 5 as in the same manner as the substrate-side contact portion 14. In addition, as an example shown in FIG. 2B, the flexible substrate 17 connected to a connector 16 mounted on the substrate 15 may be configured as the substrate-side contact portion 14 including the electrodes 14a and 14b. The substrate-side contact portion 14 (the electrodes 14a and 14b) is connected to the control unit 18 (shown in FIG. 5) randomly disposed on the substrate 15 or the like inside the lower housing 5.

An operation of the folding-type cellular phone 100 in accordance with the above-mentioned configuration will be described with reference to FIGS. 3A and 3B to 5. In order that the user performs a camera photographing, when the button 7 is pressed in the state that the housings are folded, the upper housing 3 is unfolded so that the camera 8 faces a target object. Next, when the button 7 is pressed again in the state that the upper housing 3 is unfolded, the elastic member 13 is deformed so that the conductive member 12 slidingly moves through the support hole 11 of the lower housing 5 toward an inside of the housing, whereby the substrate-side contact portion 14 is pressed. At this time, parts marked with a hatching of the conductive member 12 shown in FIG. 4 contact with the electrodes 14a and 14b of the substrate-side contact portion 14. The electrodes 14a and 14b are electrically connected to each other through the conductive member 12, whereby current flows therebetween. A timer 19 for measuring a time of a current flow outputs a signal that the button 7 is pressed for a predetermined time to the control unit 18, and the control unit 18 judges whether the camera 8 constituting an image acquisition section is activated or not. After the camera 8 is activated, the camera 8 is made to face the target object by the user using the display section 2 as a view finder of the camera 8 so that a camera photographing is performed by pressing the button 7 again.

Additionally, when the button for unfolding the housing is pressed for a predetermined time without taking off a finger, the camera is activated. Meanwhile, when the button is pressed to unfold the housing the housing and the button is pressed again for a predetermined time after the housing is opened, the camera is activated. Accordingly, a first button press and a successive “the predetermined time (a certain time)” includes the cases that a button press is continuously performed two times (the case that the button press is continuously performed) and a discontinuous case (the case that the button press is intermittently performed two times or more).

As the control unit 18 and the timer 19, various control circuits, processors, hardware, and the like may be used, but the type thereof is not limited. Generally, these parts are mounted on the substrate 15.

As described above, according to the folding-type cellular phone 100 of the embodiment of the invention, the button 7 has a camera activating function and a shutter function. Therefore, after the user unfolds the upper housing 3 by pressing the button 7 for unfolding the upper housing 3, a camera photographing can be simply performed in a short time without adjusting the cellular phone 100 by using the button 7 for activating the camera 8.

Although a mounting position of the camera 8 is not limited, it is preferable that it is provided in the other housing opposite to the one housing provided with the button 7 as in the same manner as the embodiment.

Additionally, the above-described embodiment may be considered as the folding-type cellular phone of so-called one push open type and a single button in which mechanisms for unfolding the housing and activating the camera are mechanically combined. As a functional fact, the button unit 21 achieves means for unfolding the two housings and means for activating the camera, but a configuration of the button unit 21 is not limited to a configuration of the embodiment. Thus, a shape, a number, a size, and the like of the button 7, the conductive member 12, the elastic member 13, and the substrate-side contact portion 14 can be determined without any limitation, respectively.

In addition, in the button unit 21, the configuration for unfolding the two housings is connected to the small-diameter portion 7b of the button 7. Meanwhile, an electrical connection part for activating the camera substantially is formed of the conductive member 12, the elastic member 13, and the substrate-side contact portion 14, and these are concentrically disposed in the outer periphery of the small-diameter 7b. Therefore, the button unit of the invention may be understood that a part for manipulating the hinge section and the electrical connection part for activating the camera are concentrically disposed to each other, so all units having such a shape are included in the invention.

As described above, although the invention has been described with reference to the specific embodiment, but it is clear to those skilled in the art that the invention may be modified in various forms without departing from the spirit and scope of the invention.

### INDUSTRIAL APPLICABILITY

In a folding-type cellular phone in which a camera activating function and a shutter function are assigned to a button for unfolding the housing, since a camera photographing can be promptly performed in a short time after the housing is unfolded, it is possible to take a photograph without missing an image desired by a user.

1. A folding-type cellular phone comprising:
a first housing;
a second housing;
a hinge section which connects the first housing and the second housing to each other so that the first and second housings can be folded and unfolded relative to each other;
a button unit which is provided inside the second housing and drives the hinge section so as to unfold the first housing relative to the second housing up to a position at which the second housing can be manipulated;
a control unit which operates in cooperation with the operation of the button unit driving the hinge section; and
a camera which is provided to one of the first housing and the second housing and is controlled by the control unit.

2. The folding-type cellular phone according to claim 1,
wherein the first housing includes the camera and a display section for displaying an image photographed by the camera, and
wherein the second housing includes a manipulation section.

3. The folding-type cellular phone according to claim 2,
wherein the first housing includes a display-side surface provided with the display section and a camera-side surface formed on the opposite side of the display-side surface and equipped with the camera, and
wherein a portion of the button unit is exposed to the outside of the second housing from an end surface of the hinge section.

4. The folding-type cellular phone according to claim 3,
wherein a support hole is formed in the end surface, and
wherein the button unit includes:
a button which is supported by the support hole so as to reciprocate through the support hole;
a protrusion-shaped contact formed on the button; and
a substrate-side contact portion which is connected to a substrate disposed inside the second housing and is brought into contact with the protrusion-shaped contact when the button is pressed.

5. The folding-type cellular phone according to claim 4, wherein the protrusion-shaped contact includes an elastic member that can be elastically deformed.

6. The folding-type cellular phone according to claim 5,
wherein the protrusion-shaped contact includes a conductive member which makes contact with the substrate-side contact portion when the button is pressed,
wherein the button includes a large-diameter portion and a small-diameter portion which protrudes from the large-diameter portion, and wherein the elastic member and the conductive member are formed into a ring shape and disposed adjacent to each other outside the small-diameter portion.

7. The folding-type cellular phone according to claim 5, wherein the substrate-side contact portion includes two electrodes, and the conductive member is brought into contact with the two electrodes when the button is pressed.

8. The folding-type cellular phone according to any one of claims 4 to 7, further comprising a timer for measuring a time during which the protrusion-shaped contact is in contact with the substrate-side contact portion, wherein the timer outputs a signal based on the time to the control unit.

9. A button unit for a folding-type cellular phone of one push open type having two housings, the button unit comprising:
a button which is supported by a support hole formed in an end surface of a hinge section between the two housings so as to reciprocate through the support hole,
a protrusion-shaped contact which is formed in the button,
a substrate-side contact portion which is connected to a substrate disposed in one of the two housings and is brought into contact with the protrusion-shaped contact when the button is pressed.

10. The button unit according to claim 9, wherein the protrusion-shaped contact includes an elastic member which can be elastically deformed.

11. The button unit according to claim 10,
wherein the protrusion-shaped contact includes a conductive member which makes contact with the substrate-side contact portion when the button is pressed,
wherein the button includes a large-diameter portion and a small-diameter portion protruding from the large-diameter portion, and
wherein the elastic member and the conductive member are formed into a ring shape and disposed adjacent to each other outside the small-diameter portion.

12. The button unit according to claim 11, wherein the substrate-side contact portion includes two electrodes, and the conductive member is brought into contact with the two electrodes when the button is pressed.
